(19) United States
(12) Patent Application Publication
(10) Pub. No.: US 2026/0241293 A1
(43) Pub. Date: Aug. 20, 2026

(54) SCENE DESCRIPTION UPDATE SYSTEM FOR GAME ENGINES

(71) Applicant: InterDigital CE Patent Holdings, SAS, Paris (FR)

(72) Inventors: Etienne Faivre d'Arcier, Saint Gonlay (FR); Patrice Hirtzlin, Betton (FR); Pierrick Jouet, Rennes (FR); Sylvain Lelievre, Montgermont (FR); Loic Fontaine, Noyal sur Vilaine (FR)

(21) Appl. No.: 19/162,026

(22) PCT Filed: Feb. 21, 2024
(86) PCT No.: PCT/EP2024/054452

§ 371 Date: Sep. 3, 2025

(30) Foreign Application Priority Data
Mar. 9, 2023 (EP) 23305318.0

(51) Int. Cl. A63F 13/69

(52) U.S. Cl. CPC A63F 13/69; A63F 2300/64; A63F 2300/66

(57) ABSTRACT

Some embodiments of a method may include obtaining patch data, wherein the patch data specifies an update to scene description data for a three-dimensional (3D) scene, and wherein the scene description data comprises scene element information describing at least one scene element for a subset of the scene; parsing the patch data into scene description update parameters for one or more nodes; mapping at least one of the one or more nodes of the scene description update parameters to corresponding entities of a game engine object; and applying the scene description update parameters to the mapped corresponding entities of the game engine object.

### CROSS-REFERENCE TO RELATED APPLICATIONS

The present application claims benefit of European Patent Application No. EP23305318, entitled “SCENE DESCRIPTION UPDATE SYSTEM FOR GAME ENGINES” and filed Mar. 8, 2023, which is hereby incorporated by reference in its entirety.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such scene description frameworks ensure that the timed media and the corresponding relevant virtual content are available at any time during the rendering of the application, such frameworks do not provide a description of how a user can interact with the scene objects at runtime for immersive XR experiences. Hence, there is no support of user specific XR experiences for consuming the immersive media.

### SUMMARY

A first example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for one or more nodes; mapping at least one of the one or more nodes of the scene description update parameters corresponding entities of a game engine object; and applying the scene description update parameters to the mapped corresponding entities of the game engine object.

Some embodiments of the first example method may further include mapping at least one of the one or more nodes of the scene description update parameters to corresponding entities of a node graph, wherein the node graph corresponds to at least one of the one or more nodes of the scene description update parameters.

Some embodiments of the first example method may further include applying the scene description update parameters to elements of the node graph.

In some embodiments of the first example method, wherein the one or more nodes are part of a virtual scene graph.

In some embodiments of the first example method, wherein, for at least one node, the patch data includes: an operation identifier, a path to a JavaScript Object Notation (JSON) element of the scene description data, and a value to apply.

In some embodiments of the first example method, for at least one node, the patch data includes one or more values to associate with the at least one node.

Some embodiments of the first example method may further include applying the scene description update parameters to a Graphics Library Transmissions Format (glTF) file, wherein the glTF file includes elements corresponding to a node graph.

Some embodiments of the first example method may further include applying the scene description update parameters to a file, wherein the file includes elements corresponding to a node graph.

In some embodiments of the first example method, the patch data is in JavaScript Object Notation (JSON) format.

In some embodiments of the first example method, parsing the patch data further includes detecting, in the patch data, a value structure including one or more values corresponding to a parsed node.

In some embodiments of the first example method, parsing the patch data may include: detecting, in the patch data, data indicating an operation to perform on a parsed node, wherein the parsed node is selected from the one or more nodes; and detecting, in the patch data, data indicating a location of the parsed node.

In some embodiments of the first example method, parsing the patch data may include: detecting, in the patch data, an operation field; and detecting, in the patch data, a path field corresponding to a parsed node.

In some embodiments of the first example method, the operation field indicates an operation selected from the list consisting of add, remove, replace, move, and copy.

In some embodiments of the first example method, wherein the detected operation field indicates a replace operation, and wherein applying the scene description update parameters includes deleting the parsed node corresponding to the detected path field.

In some embodiments of the first example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates an add operation, and wherein applying the scene description update parameters may include: adding, to the node graph, the parsed node corresponding to the detected path field; and adding, to the node graph, values for the parsed node, wherein the values for the parsed node are indicated by the detected value structure.

In some embodiments of the first example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates a replace operation, and wherein applying the scene description update parameters includes replacing, for the parsed node, values of the node graph with values indicated by the detected value structure.

A first example apparatus in accordance with some embodiments may include: a processor; and a non-transitory computer-readable medium storing instructions operative, when executed by the processor, to cause the apparatus to perform any of the methods listed above.

A second example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for one or more nodes; and applying the scene description update parameters to elements of a node graph, wherein the node graph corresponds to at least one of the one or more nodes.

Some embodiments of the second example method may further include mapping one or more of the elements of the node graph to corresponding entities of a game engine object.

A second example apparatus in accordance with some embodiments may include: a processor; and a non-transitory computer-readable medium storing instructions operative, when executed by the processor, to cause the apparatus to perform any of the methods listed above.

A third example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for a node; and applying the scene description update parameters for the node to corresponding entities of the game engine object.

Some embodiments of the third example method may further include applying the scene description update parameters to elements of the node graph corresponding to the node.

In some embodiments of the third example method, the one or more nodes are part of a virtual scene graph.

In some embodiments of the third example method, for at least one node, the patch data includes: an operation identifier, a path to a JavaScript Object Notation (JSON) element of the scene description data, and a value to apply.

In some embodiments of the third example method, for at least one node, the patch data includes one or more values to associate with the at least one node.

Some embodiments of the third example method may further include applying the scene description update parameters to a Graphics Library Transmissions Format (glTF) file, wherein the glTF file includes elements corresponding to a node graph.

Some embodiments of the third example method may further include applying the scene description update parameters to a file, wherein the file includes elements corresponding to a node graph.

In some embodiments of the third example method, the patch data is in JavaScript Object Notation (JSON) format.

In some embodiments of the third example method, parsing the patch data further includes detecting, in the patch data, a value structure including one or more values corresponding to a parsed node.

In some embodiments of the third example method, parsing the patch data may include: detecting, in the patch data, data indicating an operation to perform on a parsed node, wherein the parsed node is selected from the one or more nodes; and detecting, in the patch data, data indicating a location of the parsed node.

In some embodiments of the third example method, parsing the patch data may include: detecting, in the patch data, an operation field; and detecting, in the patch data, a path field corresponding to a parsed node.

In some embodiments of the third example method, the operation field indicates an operation selected from the list consisting of add, remove, replace, move, and copy.

In some embodiments of the third example method, wherein the detected operation field indicates a replace operation, and wherein applying the scene description update parameters includes deleting the parsed node corresponding to the detected path field.

In some embodiments of the third example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates an add operation, and wherein applying the scene description update parameters may include: adding, to the node graph, the parsed node corresponding to the detected path field; and adding, to the node graph, values for the parsed node, wherein the values for the parsed node are indicated by the detected value structure.

In some embodiments of the third example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates a replace operation, and wherein applying the scene description update parameters includes replacing, for the parsed node, values of the node graph with values indicated by the detected value structure.

A third example apparatus in accordance with some embodiments may include: a processor; and a non-transitory computer-readable medium storing instructions operative, when executed by the processor, to cause the apparatus to perform any of the methods listed above.

A fourth example method in accordance with some embodiments may include: obtaining patch data, parsing the patch data into scene description update parameters for one or more nodes; mapping at least one of the one or more nodes of the scene description update parameters to corresponding entities of a game engine object; and applying the scene description update parameters to the mapped corresponding entities of the game engine object.

In some embodiments of the fourth example method, wherein the patch data specifies an update to scene description data for a three-dimensional (3D) scene, and wherein the scene description data includes scene element information describing at least one scene element for a subset of the scene.

A fourth example apparatus in accordance with some embodiments may include: a processor; and a non-transitory computer-readable medium storing instructions operative, when executed by the processor, to cause the apparatus to perform any of the methods listed above.

### BRIEF DESCRIPTION OF THE DRAWINGS

FIG. 1A is a schematic side view illustrating an example waveguide display that may be used with extended reality (XR) applications according to some embodiments.

FIG. 1B is a schematic side view illustrating an example alternative display type that may be used with extended reality applications according to some embodiments.

FIG. 1C is a schematic side view illustrating an example alternative display type that may be used with extended reality applications according to some embodiments.

FIG. 1D is a system diagram illustrating an example set of interfaces for a system according to some embodiments.

FIG. 1E is a system diagram illustrating an example set of interfaces for a scene description (stored as an item in glTF. json), three video tracks, an audio track, and a JavaScript Object Notation (JSON) patch update track in an ISOBMFF file according to some embodiments.

FIG. 2 is a system diagram illustrating an example set of interfaces for an MPEG-I node hierarchy supporting elements of scene interactivity according to some embodiments.

FIG. 3 is a flowchart illustrating an example scene update process to update a scene description file.

FIG. 4 is a flowchart illustrating an example scene update process to update a node graph of a scene description according to some embodiments.

FIG. 5 is a data structure illustrating an example custom dictionary class according to some embodiments.

FIG. 6A is a data structure illustrating an example parsed node class according to some embodiments.

FIG. 6B is a code listing illustrating an example class instantiation according to some embodiments.

FIG. 7 is a flowchart illustrating an example process for reception processing of a JSON patch according to some embodiments.

FIG. 8 is a code listing for an example JSON patch parser function according to some embodiments.

FIG. 9 is a data structure illustrating an example JSON patch “add” operation structure according to some embodiments.

FIG. 10 is a code listing for an example method to add values to a game engine for a mapping system according to some embodiments.

FIG. 11 is a data structure illustrating an example JSON patch “remove” operation structure according to some embodiments.

FIG. 12 is a code listing for an example “remove” operation JSON patch parser code section according to some embodiments.

FIG. 13 is a code listing for an example “remove” operation JSON patch parser function according to some embodiments.

FIG. 14 is a data structure illustrating an example JSON patch “replace” operation structure according to some embodiments.

FIG. 15 is a code listing for an example “replace” operation section of a JSON patch parser function according to some embodiments.

FIG. 16 is a code listing for an example apply function for a mapping system according to some embodiments.

FIG. 17 is a flowchart illustrating an example process for applying patch data to corresponding entities of a game object according to some embodiments.

The entities, connections, arrangements, and the like that are depicted in-and described in connection with-the various figures are presented by way of example and not by way of limitation. As such, any and all statements or other indications as to what a particular figure “depicts,” what a particular element or entity in a particular figure “is” or “has,” and any and all similar statements-that may in isolation and out context be read as absolute and therefore limiting-may only properly be read as being constructively preceded by a clause such as “In at least one embodiment, . . . ” For brevity and clarity of presentation, this implied leading clause is not repeated ad nauseum in the detailed description.

### DETAILED DESCRIPTION

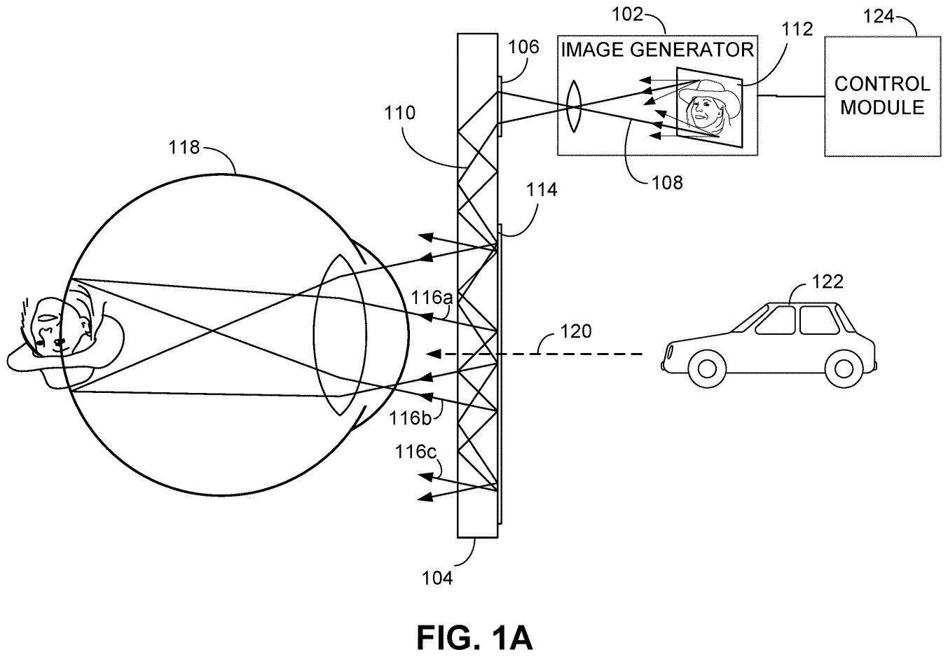

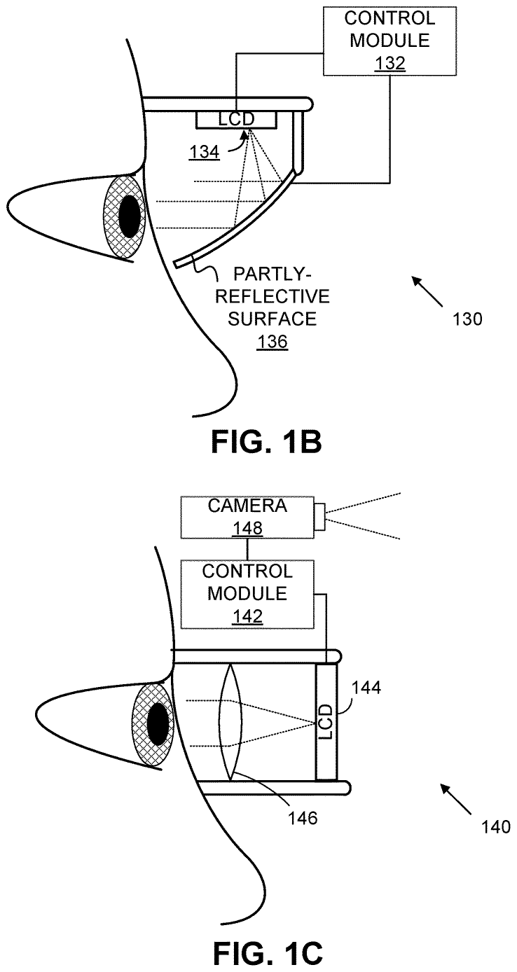

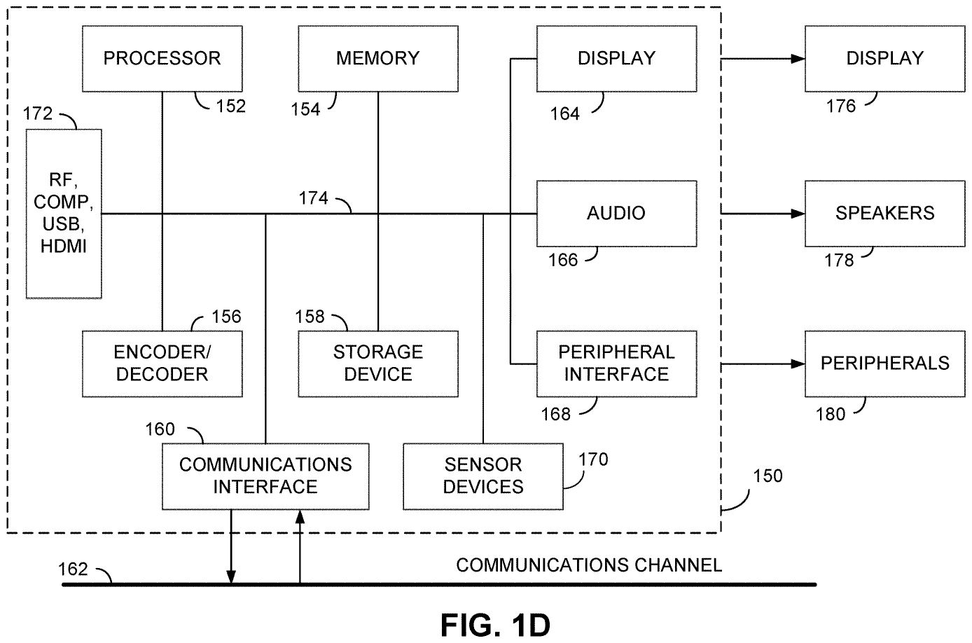

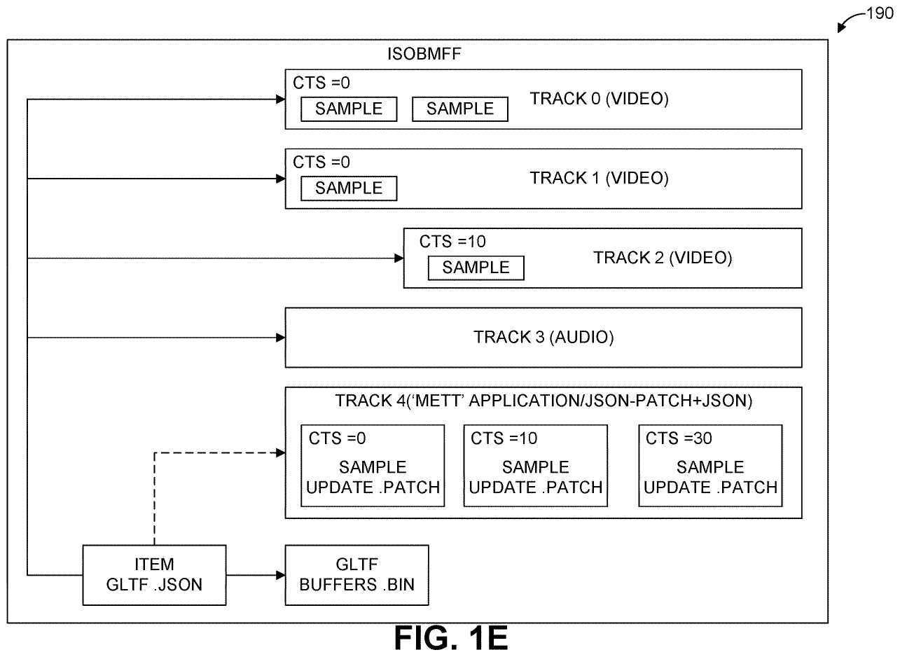

FIG. 1A is a schematic side view illustrating an example waveguide display that may be used with extended reality (XR) applications according to some embodiments. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCOS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B is a schematic side view illustrating an example alternative display type that may be used with extended reality applications according to some embodiments. In an XR head-mounted display device 130, a control module 132 controls a display 134, which may be an LCD, to display an image. The head-mounted display includes a partly-reflective surface 136 that reflects (and in some embodiments, both reflects and focuses) the image displayed on the LCD to make the image visible to the user. The partly-reflective surface 136 also allows the passage of at least some exterior light, permitting the user to see their surroundings.

FIG. 1C is a schematic side view illustrating an example alternative display type that may be used with extended reality applications according to some embodiments. In an XR head-mounted display device 140, a control module 142 controls a display 144, which may be an LCD, to display an image. The image is focused by one or more lenses of display optics 146 to make the image visible to the user. In the example of FIG. 1C, exterior light does not reach the user's eyes directly. However, in some such embodiments, an exterior camera 148 may be used to capture images of the exterior environment and display such images on the display 144 together with any virtual content that may also be displayed.

The embodiments described herein are not limited to any particular type or structure of XR display device.

FIG. 1D is a system diagram illustrating an example set of interfaces for a system according to some embodiments. An extended reality display device, together with its control electronics, may be implemented using a system such as the system of FIG. 1D. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (I2C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV. Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Scene Description Framework for XR

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such MPEG scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description including metadata describing how a user can interact with the scene objects at runtime and how these interactions may be updated during runtime of the XR application.

In XR applications, a scene description is used to combine explicit and easy-to-parse description of a scene structure and some binary representations of media content.

In time-based media streaming, the scene description itself may be time-evolving to provide the relevant virtual content for each sequence of a media stream. For instance, for advertising purpose, a virtual bottle may be displayed during a video sequence where people are drinking.

This kind of behavior can be achieved by relying on the framework defined in the Scene Description for MPEG media document, Information technology-Coded representation of immersive media—Part14: Scene Description for MPEG media, ISO/IEC DIS 23090-14: 2021 (E). A scene update mechanism based on the JavaScript Object Notation (JSON) Patch protocol as defined in IETF RFC 6902 may be used to synchronize virtual content to MPEG media streams.

FIG. 1E is a system diagram illustrating an example set of interfaces for a scene description (stored as an item in glTF. json), three video tracks, an audio track, and a JSON patch update track in an ISOBMFF (International Organization for Standardization (ISO) Base Media File Format) file according to some embodiments. FIG. 1E shows an example ISOBMFF file 190, and some embodiments may have a different number of video tracks, for example.

Although the MPEG-I Scene Description framework ensures that the timed media and the corresponding relevant virtual content are available at any time, the framework does not provide a description of how a user may interact with the scene objects at runtime for immersive XR experiences. Hence, there is no support of user specific XR experiences for consuming the immersive media.

Example embodiments as described herein may be used to provide a scene description that includes a virtual object or light source but that does not necessarily display or render the virtual object or light source even if available. In some embodiments, one or more of the following aspects may be considered in determining whether to display a virtual object or light source.

A spatial aspect may be considered in determining whether to display a virtual object or light source. For example, if the user environment is not suited (e.g. the user is too far from the rendered timed media's location) or if the user is not looking toward the right direction, or if the virtual object should be displayed on a user-specific area (e.g. above his left hand which is not yet detected), then the virtual object or light source may not be displayed.

A temporal aspect may be considered in determining whether to display a virtual object or light source. For example, if the user is not yet ready or wants to trigger himself the display of the object (e.g., using a specific gesture), the virtual object or light source may not be displayed until the appropriate trigger is detected.

In some embodiments, the scene description may specify which objects or light sources the user is allowed to manipulate or to interact with through potential haptic feedbacks.

### Runtime Interactivity

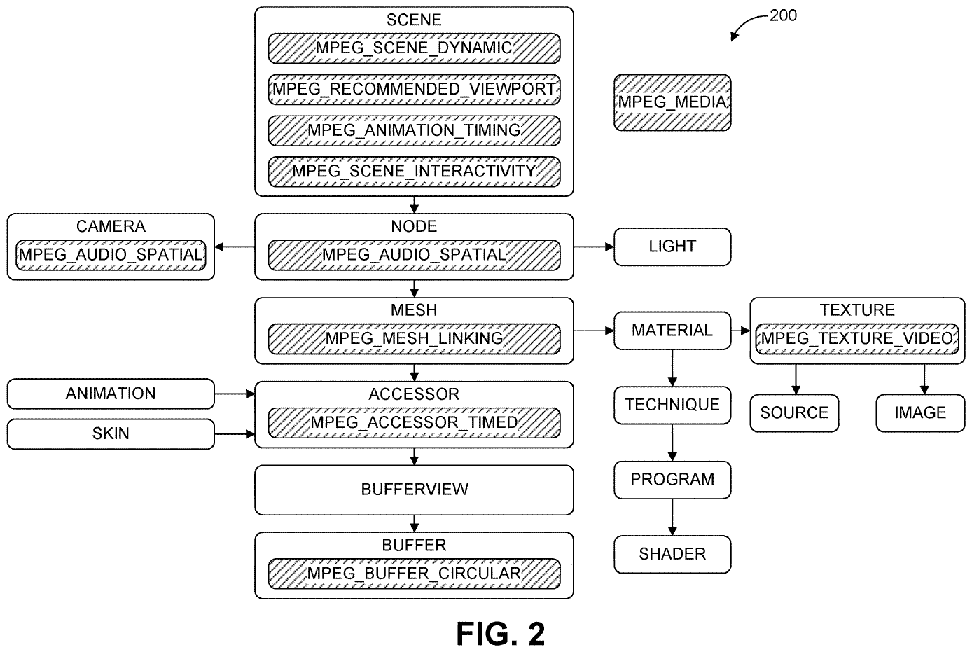

FIG. 2 is a system diagram illustrating an example set of interfaces for an MPEG-I node hierarchy supporting elements of scene interactivity according to some embodiments. According to the present principles, in addition to a node tree, behavior metadata items (examples of what are herein called ‘behaviors’) are added to the scene description and the interface diagram 200. In example embodiments, the time-evolving scene description is augmented by adding information identifying behaviors. These behaviors may be related to pre-defined virtual objects on which runtime interactivity is allowed for user specific XR experiences.

In some embodiments, these behaviors are time-evolving. In such embodiments, the behaviors may be updated through the already-existing scene description update mechanism.

In example embodiments, a behavior may be characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An interrupt action to specify how to terminate this behavior when the behavior is no longer defined in a newly received scene update. For instance, a behavior is no longer defined if the related object has been removed or if the behavior is no longer relevant for this current media (e.g., audio or video) sequence.

With the addition of these behaviors, time-dependent user interactivity in immersive content for XR experiences may be defined.

When a second scene description is received, some of the behaviors of the first scene description may be “on-going”, e.g., they are triggered, and their actions are running. The second scene description may be provided as update metadata, e.g., metadata describing the differences between the first scene description and the second description. The second scene description includes a node tree describing objects that may be common or different than objects of the first scene descriptions. Objects of the node tree of the first scene description may be no longer present in the second description. If the objects related to the running actions of the on-going behaviors are missing in the second scene description, then, these on-going behaviors are no longer appliable. If an on-going behavior is not defined in the second description, the on-going behavior is no longer appliable. The interrupt action field describes how to interrupt the running actions on the on-going behavior.

In XR applications, a scene description is used to combine explicit and easy-to-parse description of a scene structure and some binary representations of media content. The example scene update mechanism in accordance with some embodiments introduced in application EP22306885.9, filed on Dec. 15, 2022 e.g., updates a scene description file based on an event by applying a patch (e.g., a JsonPatch, XML, or others) on a scene description file.

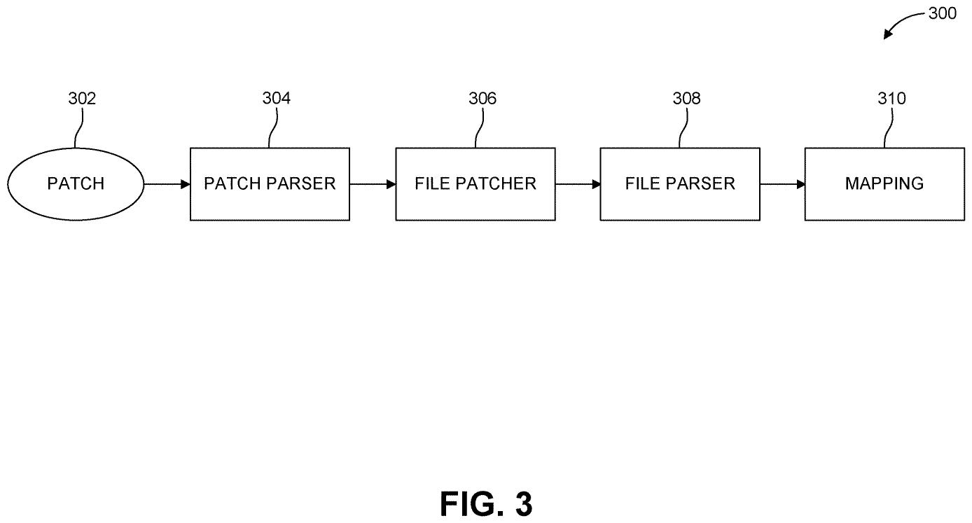

FIG. 3 is a flowchart illustrating an example process for a scene update of a scene description. FIG. 3 shows how an update may be performed in real-time applications and, more generically, in game engines. For example, a scene update may be processed as shown in FIG. 3. The application loads a scene description file, creates the associated node graph, and is ready to receive updates. A patch 302, which describes the update to be applied, is received by the application. A patch parser block 304 parses the patch and prepares update operations to be applied to the scene description file. A file patcher block 306 applies these operations to the scene description file. A file parser block 308 parses the scene description to detect the changes and to update (only) the changed game engine entities. Alternatively, the example application may reset the (previous) node graph to create a new node graph according to the new scene description file. The mapping block 310 links the parsed scene description representation with the game engine entities.

Using an implementation as shown in FIG. 3 may use more computation time and processing time. The game engine parses the entire scene description file each time an update is performed. This parsing is a computationally-heavy operation that may take more time within the context of a real-time XR application.

This application discusses, in accordance with some embodiments, a mapping system between a patch system (e.g., a JSON patch) and a scene description file, which may be a Graphics Library Transmissions Format (glTF) file, which may be implemented in the scope of an MPEG-I scene description. This application further discusses a more efficient system to update a part of a node graph issued from a scene description file. For some embodiments, a mapping system block maps parsed entities with game engine entities (e.g., a memory representation of a parsed glTF node with a Unity GameObject). For some embodiments, a game engine may be a software framework, which may include libraries, structures, include files, and other support programs and tools, which may be used to develop a video game. For some embodiments, example game engines may include Unity, Unreal Engine, CryEngine, GameMaker, Phaser, and Godot. For some embodiments, such a system does not require parsing of the entire scene description file for each update. For some embodiments, the patching of the file may be performed. In other embodiments, the example process may proceed without patching of the file.

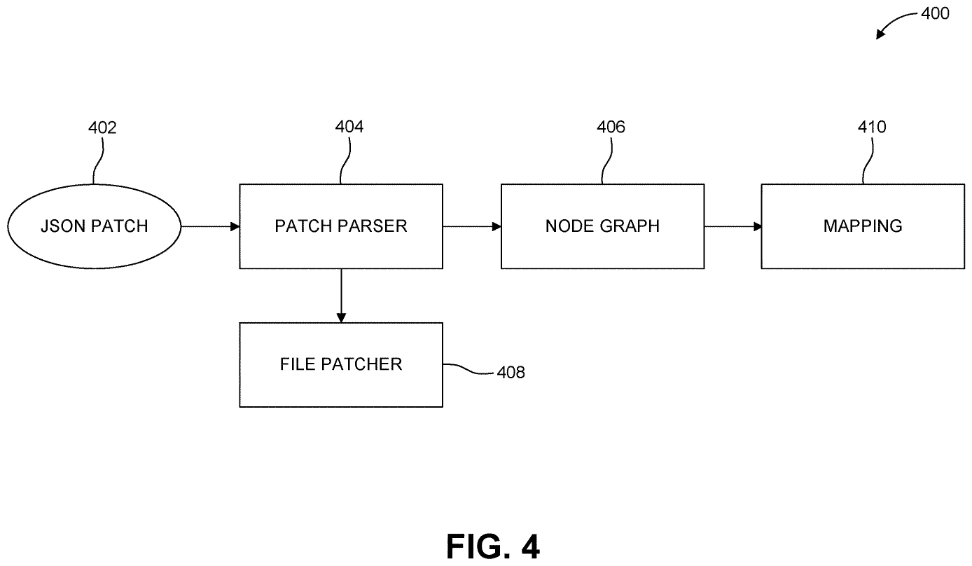

FIG. 4 is a flowchart illustrating an example scene update process to update a node graph of a scene description according to some embodiments. The node graph of a scene description file is updated in an efficient way. For some embodiments, the scene description file also may be updated. In other embodiments, the example process may proceed without updating the scene description file.

In the following example, the protocol used for the update is JAVASCRIPT OBJECT NOTATION (JSON) PATCH, Internet Engineering Task Force (IETF) Request for Comments (RFC) 6902 (April 2013), available at www<dot>rfc-editor<dot>org/rfc/rfc6902 (“JSON Patch Protocol”) and the format used for scene description is

GLTF 2.0 SPECIFICATION, Khronos 3D Formats Working Group (October 2021), available at registr<dot>khronos<dot>org/glTF/. For some embodiments, a glTF file has already been loaded in memory and the game engine is ready to perform scene updates. For some embodiments, the Unity game engine may be used. For other embodiments, other game engines may be used, such as Unreal Engine, CryEngine, GameMaker, Phaser, and Godot. Also, with some embodiments, some systems may include a patch parser block, a file parser block, and a file patcher block that are already implemented. The patch parser block may be used to parse the JSON patch and make the application understand which internal operation to execute. An example patch parser includes Json. NET, Newtonsoft, version 13.0.2, available at www<dot>newtonsoft<dot>com/json. The file parser block may be used at application startup to create a node graph based on the glTF file and to create Unity GameObjects. An example file parser includes GLTFUTILITY, Siccity, available at github<dot>com/Siccity/GLTFUtility. The file patcher may be used to apply a JSON patch to a glTF file. An example file patcher includes JSONPATCH, myquay, available at github<dot>com/myquay/JsonPatch.

For some embodiments, to update the node graph, which is a memory representation of a scene description file, and to see the result in the game engine, an update may be done as shown in FIG. 4. A JSON patch 402 with the update is received by the game engine 400 as shown on the left side of FIG. 4. The JSON patch 402 is parsed by a patch parser block 404. The content of the patch may be processed and applied to the node graph by the node graph block 406. The content of the patch also may be applied to the glTF file. For some embodiments, an update of the glTF file may be performed by the file patcher block 408. (In other embodiments, for example, an update of the glTF file may not be performed.) Such an update to the glTF file may be used to send the update to a server. For some embodiments, the update may be sent to a server if, e.g., the client later connects to such a server. As shown on the right side of FIG. 4, the mapping block 410 may map the update to the scene description representation in the game engine and apply the update to the scene description representation in the game engine.

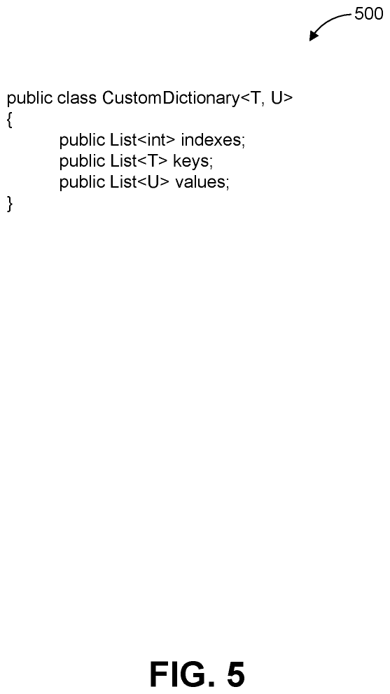

FIG. 5 is a data structure illustrating an example custom dictionary class according to some embodiments. For some embodiments, the mapping system or mapping block may use a data structure to update a game object according to the node graph data. Some embodiments may use a Unity game engine. Such a Unity game engine may be responsible to instantiate a game object, which is labeled as GameObjects for this example. The Unity game engine also may modify values of GameObjects and may remove values from GameObjects. The game object called GameObject (not the game engine) may be affected by the engine used. The Unity game object may support functionalities such as physics, lighting, and rendering data for a display. For some embodiments, a mapping structure may look like a hash table that associates a key with a value and adds an index to the table.

The indexes list of the CustomDictionary class may be an array of integers related to the nodes array in the glTF file. For example, in a glTF file, the first node of the nodes array may have an index of 0. After being parsed, the first node may be added to the indexes list with an index of 0. Since the glTF specification allows only one array of nodes in the glTF file, the existing array of nodes may be used as is.

For some embodiments, the keys list may be generated in association with loading the glTF file and starting the application the first time. A key is a representation of an item in the glTF file (e.g., a node or a mesh, among other items). A key may be used to map game engine entities. As shown in FIG. 5, the list of keys is shown as a generic type T. be able to handle a scenario in which the game engine receives a JSON patch that adds a node in the middle of a node array, some embodiments will not use a hash table with immutable keys, because all nodes listed after the added the node will be incremented and the keys will be updated accordingly.

Lastly, the list of values represents game engine entities that may be updated. For some embodiments, game engine entities may be instantiated and given initial values when the glTF file is first loaded into the game engine. For some embodiments, the list of values includes values for only the game engine entities that will be updated. With some embodiments, the list of values may include game engine entities that were recently updated. In some embodiments, the list of values may include a full set of game engine entities, including game engine entities that do not have changed values. For some embodiments, the list of values is an array of values associated with the list of keys. For some embodiments, the list of values may be unsigned, signed, positive, negative, integers, and/or floating point numbers.

For some embodiments, a virtual scene graph may use the CustomDictionary class structure 500 as shown in FIG. 5. For some embodiments, a virtual scene graph may use a CustomDictionary class structure in memory that stores indexes, keys, and values entities that correspond to a received JSON patch. In some embodiments, the virtual scene graph may be labeled “VirtualSceneGraph”.

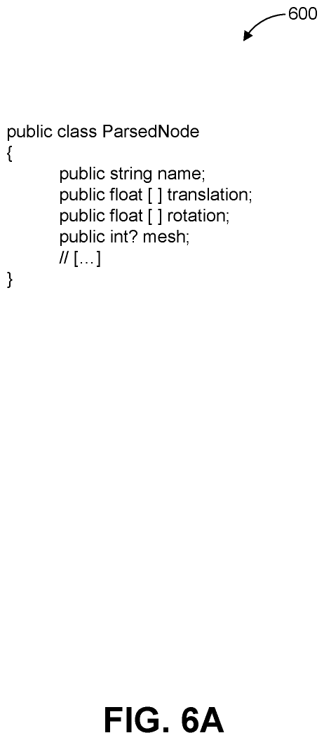

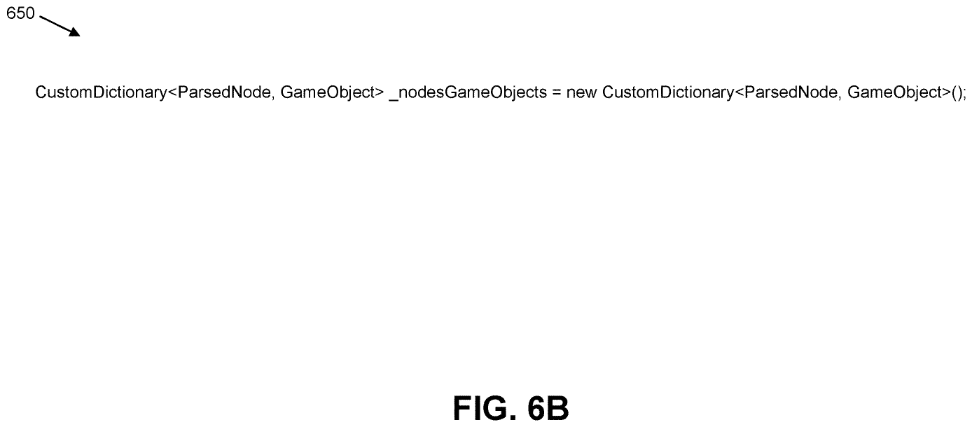

FIG. 6A is a data structure illustrating an example parsed node class according to some embodiments. The example shown in FIG. 6A is a class data structure 600 named ParsedNode. FIG. 6A lists a set of data structure elements associated with a parsed node of a node graph. For this example, there is a string name, a floating value array indicating the amount of translation of an object, a floating value array indicating the amount of rotation, and an integer number indicating which mesh is affected. For some embodiments, there may be multiple sets of data structure elements in a parsed node class in which each set of data structure elements is associated with a different mesh or different string-named element. For some embodiments, each set of data structure elements may have different elements. For example, a first set of data elements may be as shown in FIG. 6A, and a second set of data elements may have a different set of characteristics that are to be changed for an object. For example, a first set of elements may relate to a translation of an object, and a second set of elements may relate to a scale of an object.

FIG. 6B is a code listing illustrating an example class instantiation according to some embodiments. As shown in the example of FIG. 6B, the example instantiation 650 of the class CustomDictionary uses a ParsedNode class definition for items of type “T” and uses a GameObject class definition for items of type “U”. Using the example class definition shown in FIG. 5, the “keys” entities are declared as a List of type “T” items, which becomes a List of ParsedNode class objects for FIG. 6B. Also, using FIG. 5, the “values” entities are declared as a List of type “U” items, which becomes a List of GameObject class objects for FIG. 6B.

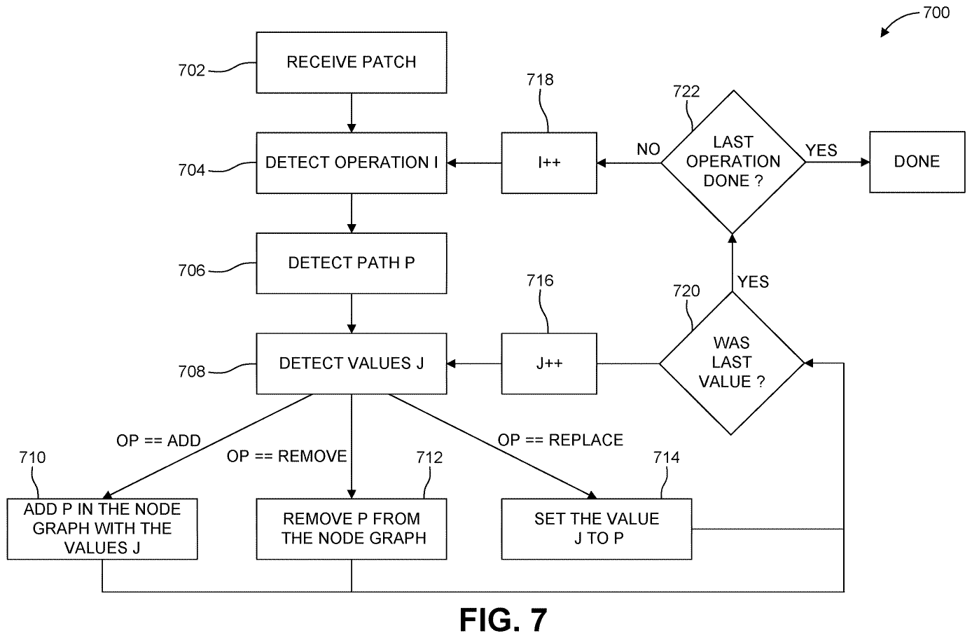

FIG. 7 is a flowchart illustrating an example process for reception processing of a JSON patch according to some embodiments. The flowchart 700 of FIG. 7 shows an example of how JSON patch operations may be handled. In some embodiments, index numbers I and J are initialized to zero. For some embodiments, a JSON patch is received 702 and an operation associated with an index number I is detected 704. For an associated JSON patch, a path location P may be detected 706, and the value associated with the index J for a “value” iteration loop also may be detected 708.

The example flowchart of FIG. 7 handles add, remove, and replace operations. Some embodiments may handle other operations. For some embodiments, a move operation may move “values” entities from one node to another node of a node graph. For some embodiments, a copy operation may copy “values” entities from an existing node to another node of a node graph. If the operation associated with index I is an add operation 710, then path location P is added to the node graph and the current value for index J is added to path location P. If the operation associated with index I is a remove operation 712, then path location P is removed from the node graph. If the operation associated with index I is a replace operation 714, then the current value for index J is replaced with the value at path location P.

After the add, remove, or replace operation is handled for the current index J, a check 720 is performed to determine if the index J has reached the end of the list of values to update. If there are more iterations to perform for the “value” loop, then the index J is incremented 716, and the new value associated with the updated index J is detected for another pass through the “value” loop. If the “value” loop is done, then a check 722 is performed to determine if the “operation” loop is done. If “yes”, then the code block is exited. If “no”, then the operation index I is incremented 718, and the new operation associated with the updated index I is detected for another pass through the “operation” loop.

For some embodiments, the add, remove, and replace operations of FIG. 7 may be integrated into a virtual scene graph class. A mapping process block may be used to reference the scene description model with a game engine model. Such a mapping process block may only access a node graph but not update the node graph. For some embodiments, when receiving a patch update, the patch parser may be the only block that updates the node graph. For some embodiments, application logic or an application script may modify the node graph at runtime.

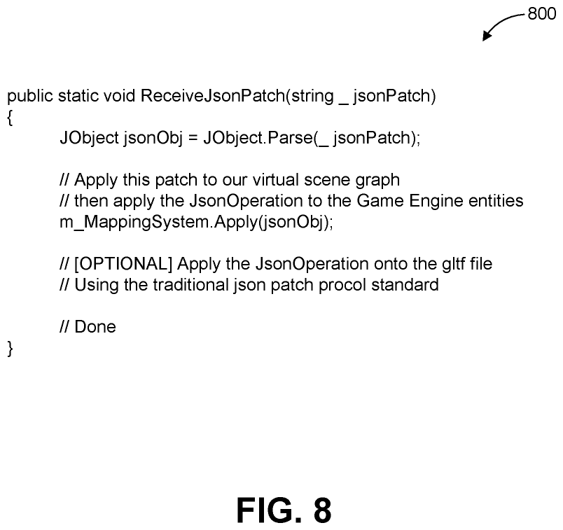

FIG. 8 is a code listing for an example JSON patch parser function according to some embodiments. For some embodiments, when receiving a JSON patch, the patch parser block converts the patch into a JObject type object, which may be described using, for example, the Newtonsoft. json library or the . NET JSON serializer class System. Text. Json, and which may be read by the mapping system. Other types of objects may be used for some embodiments. The JObject type object may act as a selector on a list, such as a list that references all the objects in a file. For some embodiments, the JObject type object is instantiated by the Newtonsoft. json library when using the method SelectTokens(string value), which returns an enum of JToken with corresponding data inside.

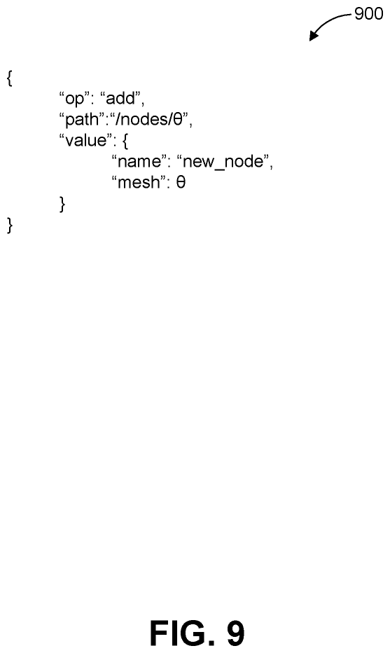

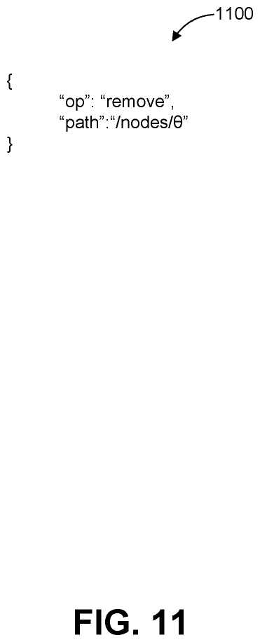

FIG. 8 shows an example of a function 800 for receiving a JSON patch and converting the patch into a format usable by a mapping function. For some embodiments, the example function ReceiveJsonPatch() may be called by a higher level function. Such a function call may pass a string parameter named _jsonPatch as a function call input parameter. For some embodiments, example _jsonPatch parameter strings may be as shown in FIGS. 9, 11, and/or 14.

Within the function ReceiveJsonPatch(), the string jsonPatch is passed as an input to the JObject. Parse() function call. The function JObject. Parse() parses the received patch (_jsonPatch) and returns a pointer to the parsed JSON patch object. A JSON object type named jsonObj is created and set equal to this returned JSON patch object pointer. The JSON object json Obj is passed to the mapping system via a function call of m_MappingSystem. Apply() to apply the parsed JSON patch to the virtual scene graph and to apply a JsonOperation to the game engine entities structure.

For some embodiments, the JsonOperation is the “op” field (“operation field”) shown in FIG. 7. For the example shown in FIG. 7, the “op” field may designate an “add”, “remove”, or “replace” operation for some embodiments. For some embodiments, the JsonOperation may be applied to the glTF file using the JSON patch protocol (not shown).

FIG. 9 is a data structure illustrating an example JSON patch “add” operation structure according to some embodiments. For some embodiments, an “add” operation data structure may have “op”, “path”, and “value” elements. For the example of FIG. 9, the “op” element is equal to “add”. The “path” element points to node 0(/nodes/0 ). The “value” element has two sub-elements: “name” and “mesh”. For the “value” element of FIG. 9, the “name” sub-element is equal to “new_node”, and the “mesh” sub-element is mesh 0.

For the example data structure 900 shown in FIG. 9, node 0 is added to the node graph. The string “new_node” is added as a first value sub-element for the “name” field of new node 0. A value of 0 is added as a second value sub-element for the “mesh” field of new node 0. If there are additional nodes in the node graph after node 0, then the index value for those additional nodes may be incremented to make room for new node 0.

For some embodiments, the “path” element may indicate a sub-location within a node. For some embodiments, the “value” element may be an array of values. For some embodiments, the example data structure shown in FIG. 9 may be part of a larger data structure that has other operations.

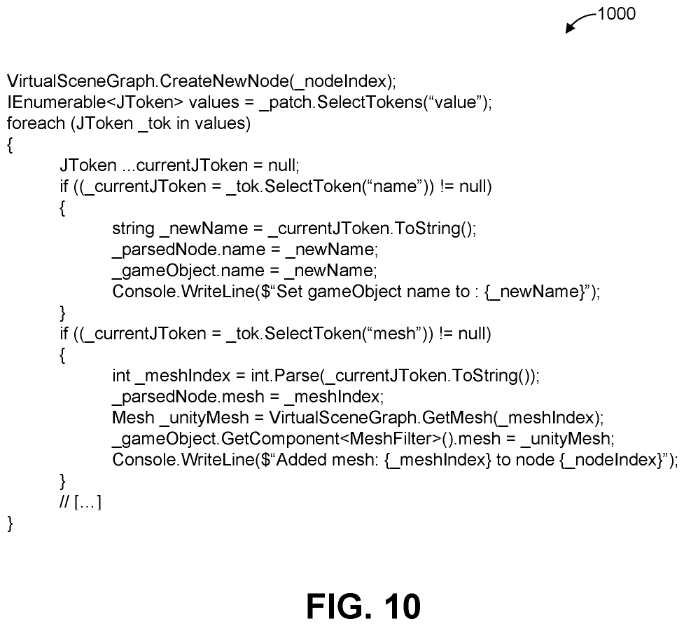

FIG. 10 is a code listing for an example method to add values to a game engine for a mapping system according to some embodiments. A JSON patch is parsed for instructions to apply to the parsed node and the game engine object. The mapping system may add values to the game engine. For the example code listing 1000 of FIG. 10, the structure of FIG. 9 may be referred to for understanding of the code section shown in FIG. 10. For the example code section shown in FIG. 10, the function call to VirtualSceneGraph. CreateNewNode(_nodeIndex) creates a new node in the virtual scene graph for the passed node index, _nodeIndex.

For some embodiments, the example definition of the class CustomDictionary shown in FIG. 5 may be used with the virtual scene graph.

A token to the “value” element of the JSON patch object structure is selected and set to a token type named values. For each element in the values structure, a code loop is performed.

A token to the “name” element is selected and set to the current token. If such a “name” element exists, then the corresponding “name” string is parsed. The parsed node and the gameObject are set to the parsed “name” string. A line is outputted to the console to tell the user the name of the gameObject.

A token to the “mesh” element is selected and set to the current token. If such a “mesh” element exists, then the corresponding “mesh” index/string is parsed. The parsed node's mesh value and the corresponding gameObject's mesh value are set to the parsed “mesh” index. A line is outputted to the console to tell the user the mesh index number.

Other elements may be parsed from the JSON patch structure. The code section shown in FIG. 10 is an example of two parsed elements. If other fields are in the JSON patch, then those fields are detected, parsed, and applied to the parsed node and the game engine object.

FIG. 11 is a data structure illustrating an example JSON patch “remove” operation structure according to some embodiments. For some embodiments, a “remove” operation data structure may have “op” and “path” elements. For the example data structure 1100 of FIG. 11, the “op” element is equal to “remove”. The “path” element points to node 0(/nodes/0 ). There is no “value” element listed because the node is being removed. For the example shown in FIG. 11, node 0 is removed from the node graph. For some embodiments, the example data structure shown in FIG. 11 may be part of a larger data structure that has other operations.

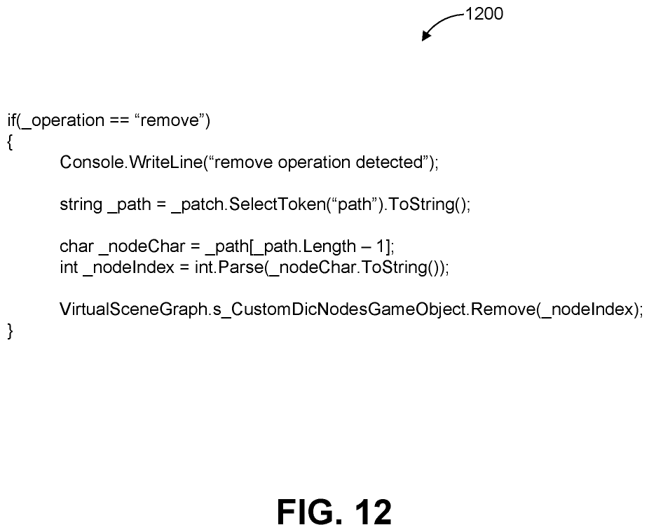

FIG. 12 is a code listing for an example “remove” operation JSON patch parser code section according to some embodiments. A JSON patch with a “remove” operation code specifies which component remove. FIG. 12 shows an example patch parser remove operation 1200. For the corresponding example shown in FIG. 11, the node at index 0 of the nodes array is removed.

For the example of FIG. 12, a line is displayed on the console to tell the user that a remove operation has been detected in the patch. A token to the “path” element is selected, and the corresponding “path” string is parsed. The last character of the “path” string is stripped off and converted to the node index number. That node index is removed from the virtual scene graph via a call to the function Remove().

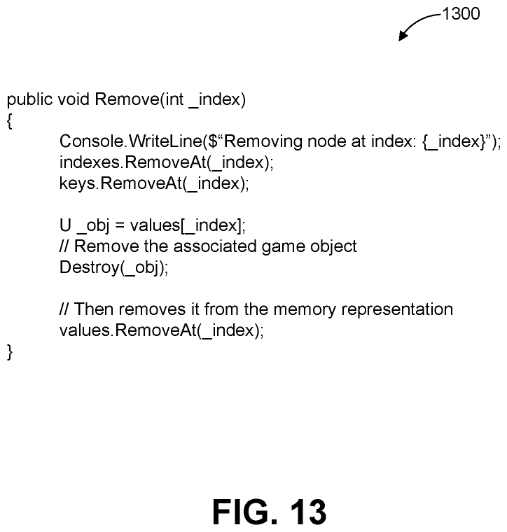

FIG. 13 is a code listing for an example “remove” operation JSON patch parser function according to some embodiments. For some embodiments, the example function 1300 shown in FIG. 13 may be called by the code section shown in FIG. 12. For some embodiments, the example shown in FIG. 13 is a mapping system implementation of a remove() function for removing an entity associated with the passed index.

For the example of FIG. 13, a line is displayed on the console to tell the user that the entity at the passed index is being removed. Calls are made to the function RemoveAt() to remove the indexes, keys, and values entities stored for the passed index number. The associated game object for the passed index is also removed/destroyed. As shown in the example of FIG. 13, the passed index number is used as the index for the values□ array.

For some embodiments, the virtual scene graph's node associated with the passed index number is the node for which the indexes, keys, and values entities are removed from memory. The last line of the code section shown in FIG. 12 shows the use of such a virtual scene graph structure. For some embodiments, the virtual scene graph uses a class structure as shown in FIG. 5.

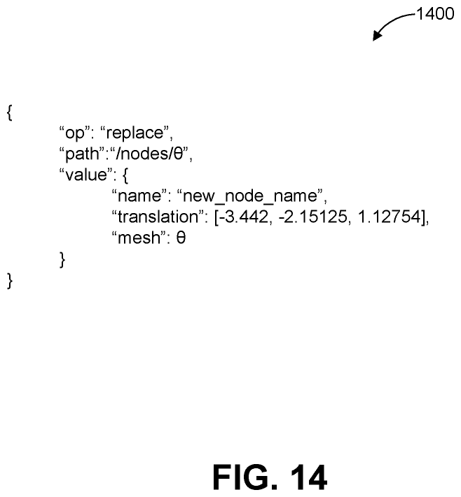

FIG. 14 is a data structure illustrating an example JSON patch “replace” operation structure according to some embodiments. For some embodiments, a “replace” operation data structure may have “op”, “path”, and “value” elements. For the example data structure 1400 of FIG. 14, the “op” element is equal to “replace”. The “path” element points to node 0(/nodes/0 ). The “value” element has three sub-elements: “name”, “translation”, and “mesh”. For the “value” element of FIG. 14, the “name” sub-element is equal to “new_node_name”, the “translation” sub-element is equal to an array of three values, and the “mesh” sub-element is mesh 0.

For the example shown in FIG. 14, node 0 is replaced with updated values in the node graph. The string “new_node_name” is the first value sub-element, and the string is used to update the “name” field of node 0. An array of three values is the second value sub-element, and the array is used to update the “translation” field of node 0. In the example of FIG. 14, the “translation” array is [−3.442, −2.15125, 1.12754]. For some embodiments, use of such a translation array may add −3.442 to an x-position in space, may add −2.15125 to a y-position in space, and may add a 1.12754 to a z-position in space. A value of 0 is the third value sub-element, and the value is used to update the “mesh” field of node 0.

For some embodiments, the “path” element may indicate a sub-location within a node. For some embodiments, the “value” element may be an array of values. For some embodiments, the example data structure shown in FIG. 14 may be part of a larger data structure that has other operations.

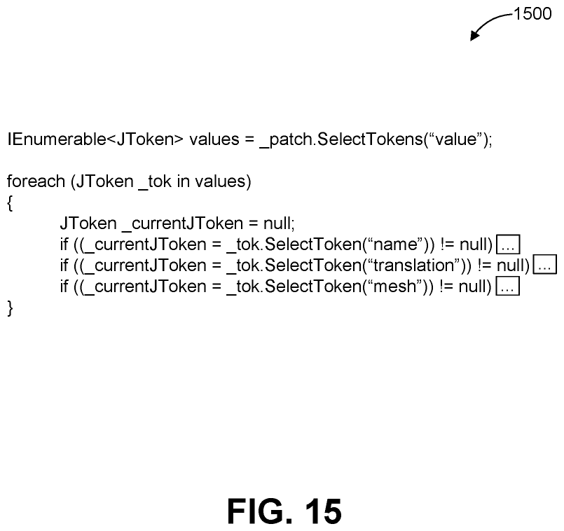

FIG. 15 is a code listing for an example “replace” operation section of a JSON patch parser function according to some embodiments. If a JSON patch with replace code is received, the parser may update the node with the new fields in the “value” portion of the structure. The code listing 1500 of FIG. 15 has some similarities to FIG. 10.

A token to the “name” element is selected and set to the current token. If such a “name” element exists, then code (not shown) may be executed that replaces “name” string with the new name in the patch.

A token to the “translation” element is selected and set to the current token. If such a “translation” element exists, then code (not shown) may be executed that replaces “translation” values with the new values in the patch.

A token to the “mesh” element is selected and set to the current token. If such a “mesh” element exists, then code (not shown) may be executed that replaces “mesh” index with the new index value in the patch.

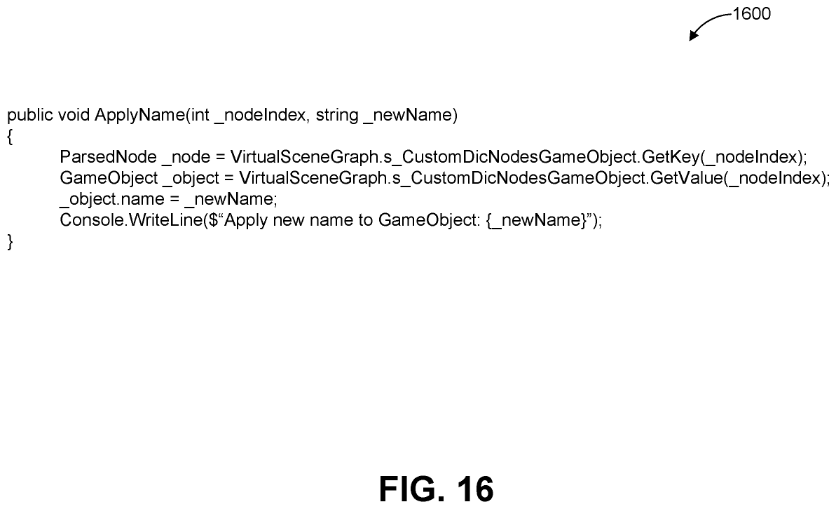

FIG. 16 is a code listing for an example apply function for a mapping system according to some embodiments. FIG. 16 shows an example function 1600 for a mapping system to apply a JSON operation to the corresponding game engine entities. For some embodiments, a node index number (_nodeIndex) is passed to the function ApplyName(). For the passed node index, a pointer to a list of keys within the virtual scene graph may be retrieved. Labeled as “_node”, an instantiation of the class ParsedNode is set to this pointer, which causes the JSON operation's list of keys to be applied to the parsed node's entities. For some embodiments, the example definition of the class CustomDictionary shown in FIG. 5 may be used with the virtual scene graph. For some embodiments, the example definition of the class ParsedNode shown in FIG. 6A may be used for “_node”. The class ParsedNode may have other elements in addition to or in place of the elements shown in FIG. 6A.

For the passed node index, a pointer to a list of values within the virtual scene graph may be retrieved. Labeled as “_object”, an instantiation of the class GameObject is set to this pointer, which causes the JSON operation's list of values to be applied to the game object's entities. The name element within the game object is set to the passed node name string, which is labeled as “_newName” in the function header line. The name of the (new) node is written to the console to inform the user. For some embodiments, a Unity—Scripting Application Programming Interface (API), for example, may be used to delineate the elements of the class GameObject. A Unity-Scripting API may be obtained from unity3d<dot>com.

For some embodiments, the following code order may be used. The ReceiveJsonPatch() function shown in FIG. 8 receives a JSON patch. The string structure jsonPatch is a JSON parameter string structure, which may be as shown in FIGS, 9, 11, and/or 14. The Parse() function shown in FIG. 8 may be a function call to a Newtonsoft. Json library function, for example. The return value of the Parse function, which is a pointer to the parsed JSON object, is set to the newly created JObject called jsonObj. The mapping system calls an Apply() function to detect the operation (“op”) parameter of the JSON parameter structure. For example, the “op” parameter may be equal to “remove”. As a result, the code snippet shown in FIG. 12 is called, and the last line of FIG. 12 causes a function call of the function Remove(), an example of which is shown in FIG. 13. FIG. 16 shows an example of the last step of a name change, which applies scene description update parameters to the corresponding mapped entities of the game engine object.

For some embodiments, a scene description file is updated on a periodic basis. For example, a client may join a server after a while (say, 1 hour after an application has launched). The client may need to obtain the entities (nodes) that have been created since the application launched. The server may generate a whole scene description file a patch containing the data for this particular client. For some embodiments, the server may keep scene description file versions of the application in the version of patches of a full scene description file.

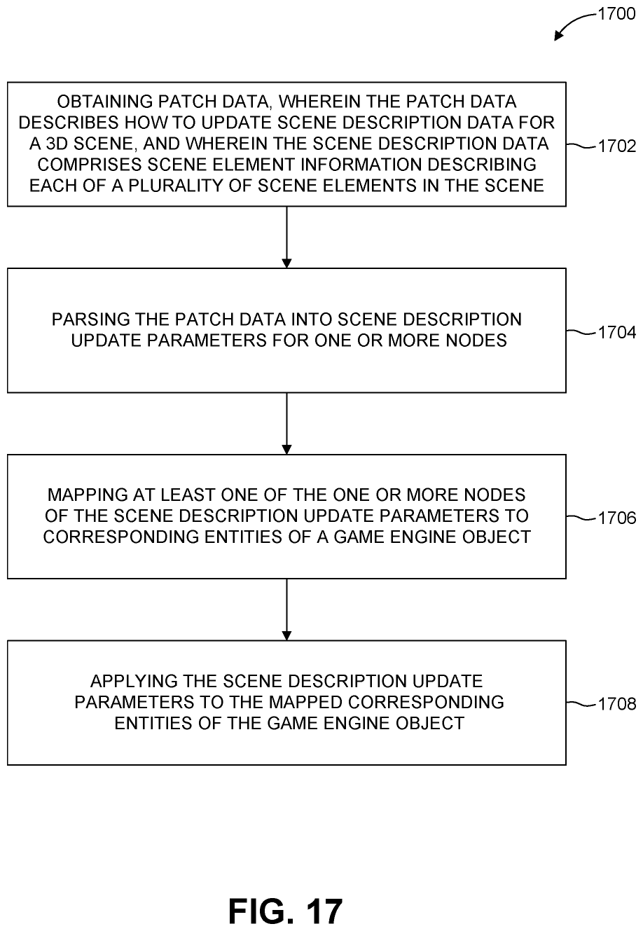

FIG. 17 is a flowchart illustrating an example process for applying patch data to corresponding entities of a game object according to some embodiments. For some embodiments, an example process 1700 may include obtaining 1702 patch data, wherein the patch data describes how to update scene description data for a three-dimensional (3D) scene, and wherein the scene description data may include scene element information describing each of a plurality of scene elements in the scene. For some embodiments, the example process 1700 may further include parsing 1704 the patch data into scene description update parameters for one or more nodes. For some embodiments, the example process 1700 may further include mapping 1706 at least one of the one or more nodes of the scene description update parameters to corresponding entities of a game engine object. For some embodiments, the example process 1700 may further include applying 1708 the scene description update parameters to the mapped corresponding entities of the game engine object.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example method in accordance with some embodiments may include obtaining patch data, wherein the patch data describes how to update scene description data for a three-dimensional (3D) scene, and wherein the scene description data may include scene element information describing each of a plurality of scene elements in the scene; parsing the patch data into scene description update parameters for one or more nodes; mapping at least one of the one or more nodes of the scene description update parameters to corresponding entities of a game engine object; and applying the scene description update parameters to the mapped corresponding entities of the game engine object.

Some embodiments of an example method may further include mapping at least one of the one or more nodes of the scene description update parameters to corresponding entities of a node graph, wherein the node graph corresponds to at least one of the one or more nodes of the scene description update parameters.

Some embodiments of an example method may further include applying the scene description update parameters to elements of the node graph.

In some embodiments of an example method, the one or more nodes are part of a virtual scene graph.

In some embodiments of an example method, for at least one node, the patch data may include an operation identifier, a path to a JavaScript Object Notation (JSON) element of the scene description data, and a value to apply.

In some embodiments of an example method, for at least one node, the patch data includes one or more values to associate with the at least one node.

Some embodiments of an example method may further include applying the scene description update parameters to a Graphics Library Transmissions Format (glTF) file, wherein the glTF file may include elements corresponding to a node graph.

Some embodiments of an example method may further include applying the scene description update parameters to a file, wherein the file includes elements corresponding to a node graph.

In some embodiments of an example method, the patch data may be in JavaScript Object Notation (JSON) format.

In some embodiments of an example method, parsing the patch data further includes detecting, in the patch data, a value structure including one or more values corresponding to a parsed node.

In some embodiments of an example method, parsing the patch data includes: detecting, in the patch data, data indicating an operation to perform on a parsed node, wherein the parsed node is selected from the one or more nodes; and detecting, in the patch data, data indicating a location of the parsed node.

In some embodiments of an example method, parsing the patch data may include: detecting, in the patch data, an operation field; and detecting, in the patch data, a path field corresponding to a parsed node.

In some embodiments of an example method, the operation field may indicate an operation selected from the list consisting of add, remove, replace, move, and copy.

In some embodiments of an example method, the detected operation field may indicate a replace operation, and applying the scene description update parameters may include deleting the parsed node corresponding to the detected path field.

In some embodiments of an example method parsing the patch data may include detecting, in the patch data, an operation field; detecting, in the patch data, a path field corresponding to a parsed node; and detecting, in the patch data, a value structure that may include one or more values corresponding to the parsed node, wherein the detected operation field may indicate an add operation, and wherein applying the scene description update parameters may include adding, to the node graph, the parsed node corresponding to the detected path field; and adding, to the node graph, values for the parsed node, wherein the values for the parsed node may be indicated by the detected value structure.

In some embodiments of an example method, parsing the patch data may include detecting, in the patch data, an operation field; detecting, in the patch data, a path field corresponding to a parsed node; and detecting, in the patch data, a value structure that may include one or more values corresponding to the parsed node, wherein the detected operation field may indicate a replace operation, and wherein applying the scene description update parameters may include replacing, for the parsed node, values of the node graph with values indicated by the detected value structure.

An example apparatus in accordance with some embodiments may include a processor; and a non-transitory computer-readable medium storing instructions operative, when executed by the processor, to cause the apparatus to perform any one of the methods listed above.

Another example method in accordance with some embodiments may include obtaining patch data, wherein the patch data describes how to update scene description data for a three-dimensional (3D) scene, and wherein the scene description data may include scene element information describing each of a plurality of scene elements in the scene; parsing the patch data into scene description update parameters for one or more nodes; and applying the scene description update parameters to elements of a node graph, wherein the node graph corresponds to at least one of the one or more nodes.

Some embodiments of another example method may further include mapping one or more of the elements of the node graph to corresponding entities of a game engine object.

Another example apparatus in accordance with some embodiments may include a processor; and a non-transitory computer-readable medium storing instructions operative, when executed by the processor, to cause the apparatus to perform any one of the methods listed above.

An additional example method in accordance with some embodiments may include obtaining patch data, wherein the patch data describes how to update scene description data for a three-dimensional (3D) scene, and wherein the scene description data may include scene element information describing each of a plurality of scene elements in the scene; parsing the patch data into scene description update parameters for a node; and applying the scene description update parameters for the node to corresponding entities of the game engine object.

Some embodiments of an additional example method may further include applying the scene description update parameters to elements of the node graph corresponding to the node.

In some embodiments of an additional method, the one or more nodes may be part of a virtual scene graph.

In some embodiments of an additional method, for at least one node, the patch data may include: an operation identifier, a path to a JavaScript Object Notation (JSON) element of the scene description data, and a value to apply.

In some embodiments of an additional method, for at least one node, the patch data includes one or more values to associate with the at least one node.

Some embodiments of an additional example method may further include applying the scene description update parameters to a Graphics Library Transmissions Format (glTF) file, wherein the glTF file may include elements corresponding to a node graph.

Some embodiments of an additional method may further include applying the scene description update parameters to a file, wherein the file includes elements corresponding to a node graph.

In some embodiments of an additional method the patch data may be in JavaScript Object Notation (JSON) format.

In some embodiments of an additional method, parsing the patch data further includes detecting, in the patch data, a value structure including one or more values corresponding to a parsed node.

In some embodiments of an additional method, parsing the patch data includes: detecting, in the patch data, data indicating an operation to perform on a parsed node, wherein the parsed node is selected from the one or more nodes; and detecting, in the patch data, data indicating a location of the parsed node.

In some embodiments of an additional method parsing the patch data may include: detecting, in the patch data, an operation field; and detecting, in the patch data, a path field corresponding to a parsed node.

In some embodiments of an additional method, the operation field may indicate an operation selected from the list consisting of add, remove, replace, move, and copy.

In some embodiments of an additional method, the detected operation field may indicate a replace operation, and applying the scene description update parameters may include deleting the parsed node corresponding to the detected path field.

In some embodiments of an additional method parsing the patch data may include detecting, in the patch data, an operation field; detecting, in the patch data, a path field corresponding to a parsed node; and detecting, in the patch data, a value structure may include one or more values corresponding to the parsed node, wherein the detected operation field may indicate an add operation, and wherein applying the scene description update parameters may include: adding, to the node graph, the parsed node corresponding to the detected path field; and adding, to the node graph, values for the parsed node, wherein the values for the parsed node may be indicated by the detected value structure.

In some embodiments of an additional method, parsing the patch data may include: detecting, in the patch data, an operation field; detecting, in the patch data, a path field corresponding to a parsed node; and detecting, in the patch data, a value structure may include one or more values corresponding to the parsed node, wherein the detected operation field indicates a replace operation, and wherein applying the scene description update parameters may include replacing, for the parsed node, values of the node graph with values indicated by the detected value structure.

An additional example apparatus in accordance with some embodiments may include a processor; and a non-transitory computer-readable medium storing instructions operative, when executed by the processor, to cause the apparatus to perform any one of the methods listed above.

A first example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for one or more nodes; mapping at least one of the one or more nodes of the scene description update parameters to corresponding entities of a game engine object; and applying the scene description update parameters to the mapped corresponding entities of the game engine object.

Some embodiments of the first example method may further include mapping at least one of the one or more nodes of the scene description update parameters to corresponding entities of a node graph, wherein the node graph corresponds to at least one of the one or more nodes of the scene description update parameters.

Some embodiments of the first example method may further include applying the scene description update parameters to elements of the node graph.

In some embodiments of the first example method, wherein the one or more nodes are part of a virtual scene graph.

In some embodiments of the first example method, wherein, for at least one node, the patch data includes: an operation identifier, a path to a JavaScript Object Notation (JSON) element of the scene description data, and a value to apply.

In some embodiments of the first example method, for at least one node, the patch data includes one or more values to associate with the at least one node.

Some embodiments of the first example method may further include applying the scene description update parameters to a Graphics Library Transmissions Format (glTF) file, wherein the glTF file includes elements corresponding to a node graph.

Some embodiments of the first example method may further include applying the scene description update parameters to a file, wherein the file includes elements corresponding to a node graph.

In some embodiments of the first example method, the patch data is in JavaScript Object Notation (JSON) format.

In some embodiments of the first example method, parsing the patch data further includes detecting, in the patch data, a value structure including one or more values corresponding to a parsed node.

In some embodiments of the first example method, parsing the patch data may include: detecting, in the patch data, data indicating an operation to perform on a parsed node, wherein the parsed node is selected from the one or more nodes; and detecting, in the patch data, data indicating a location of the parsed node.

In some embodiments of the first example method, parsing the patch data may include: detecting, in the patch data, an operation field; and detecting, in the patch data, a path field corresponding to a parsed node.

In some embodiments of the first example method, the operation field indicates an operation selected from the list consisting of add, remove, replace, move, and copy.

In some embodiments of the first example method, wherein the detected operation field indicates a replace operation, and wherein applying the scene description update parameters includes deleting the parsed node corresponding to the detected path field.

In some embodiments of the first example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates an add operation, and wherein applying the scene description update parameters may include: adding, to the node graph, the parsed node corresponding to the detected path field; and adding, to the node graph, values for the parsed node, wherein the values for the parsed node are indicated by the detected value structure.

In some embodiments of the first example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates a replace operation, and wherein applying the scene description update parameters includes replacing, for the parsed node, values of the node graph with values indicated by the detected value structure.

A first example apparatus in accordance with some embodiments may include: a processor; and a non-transitory computer-readable medium storing instructions operative, when executed by the processor, to cause the apparatus to perform any of the methods listed above.

A second example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for one or more nodes; and applying the scene description update parameters to elements of a node graph, wherein the node graph corresponds to at least one of the one or more nodes.

Some embodiments of the second example method may further include mapping one or more of the elements of the node graph to corresponding entities of a game engine object.

A second example apparatus in accordance with some embodiments may include: a processor; and a non-transitory computer-readable medium storing instructions operative, when executed by the processor, to cause the apparatus to perform any of the methods listed above.

A third example method in accordance with some embodiments may include: obtaining patch data, wherein the patch data specifies an update to scene description data for a three-dimensional (3D) scene, and wherein the scene description data includes scene element information describing at least one scene element for a subset of the scene; parsing the patch data into scene description update parameters for a node; and applying the scene description update parameters for the node to corresponding entities of the game engine object.

Some embodiments of the third example method may further include applying the scene description update parameters to elements of the node graph corresponding to the node.

In some embodiments of the third example method, the one or more nodes are part of a virtual scene graph.

In some embodiments of the third example method, for at least one node, the patch data includes: an operation identifier, a path to a JavaScript Object Notation (JSON) element of the scene description data, and a value to apply.

In some embodiments of the third example method, for at least one node, the patch data includes one or more values to associate with the at least one node.

Some embodiments of the third example method may further include applying the scene description update parameters to a Graphics Library Transmissions Format (glTF) file, wherein the glTF file includes elements corresponding to a node graph.

Some embodiments of the third example method may further include applying the scene description update parameters to a file, wherein the file includes elements corresponding to a node graph.

In some embodiments of the third example method, the patch data is in JavaScript Object Notation (JSON) format.

In some embodiments of the third example method, parsing the patch data further includes detecting, in the patch data, a value structure including one or more values corresponding to a parsed node.

In some embodiments of the third example method, parsing the patch data may include: detecting, in the patch data, data indicating an operation to perform on a parsed node, wherein the parsed node is selected from the one or more nodes; and detecting, in the patch data, data indicating a location of the parsed node.

In some embodiments of the third example method, parsing the patch data may include: detecting, in the patch data, an operation field; and detecting, in the patch data, a path field corresponding to a parsed node.

In some embodiments of the third example method, the operation field indicates an operation selected from the list consisting of add, remove, replace, move, and copy.

In some embodiments of the third example method, wherein the detected operation field indicates a replace operation, and wherein applying the scene description update parameters includes deleting the parsed node corresponding to the detected path field.

In some embodiments of the third example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates an add operation, and wherein applying the scene description update parameters may include: adding, to the node graph, the parsed node corresponding to the detected path field; and adding, to the node graph, values for the parsed node, wherein the values for the parsed node are indicated by the detected value structure.

In some embodiments of the third example method, parsing the patch data may include: detecting, in the patch data, an operation field; detecting, in the patch data, a path field corresponding to a parsed node; and detecting, in the patch data, a value structure including one or more values corresponding to the parsed node, wherein the detected operation field indicates a replace operation, and wherein applying the scene description update parameters includes replacing, for the parsed node, values of the node graph with values indicated by the detected value structure.

A third example apparatus in accordance with some embodiments may include: a processor; and a non-transitory computer-readable medium storing instructions operative, when executed by the processor, to cause the apparatus to perform any of the methods listed above.

A fourth example method in accordance with some embodiments may include: obtaining patch data, parsing the patch data into scene description update parameters for one or more nodes; mapping at least one of the one or more nodes of the scene description update parameters to corresponding entities of a game engine object; and applying the scene description update parameters to the mapped corresponding entities of the game engine object.

In some embodiments of the fourth example method, wherein the patch data specifies an update to scene description data for a three-dimensional (3D) scene, and wherein the scene description data includes scene element information describing at least one scene element for a subset of the scene.

A fourth example apparatus in accordance with some embodiments may include: a processor; and a non-transitory computer-readable medium storing instructions operative, when executed by the processor, to cause the apparatus to perform any of the methods listed above.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining patch data,
wherein the patch data specifies an update to scene description data for a three-dimensional (3D) scene, and
wherein the scene description data comprises scene element information describing at
least one scene element for a subset of the scene;
parsing the patch data into scene description update parameters for one or more nodes;
mapping at least one of the one or more nodes of the scene description update parameters to corresponding entities of a game engine object; and
applying the scene description update parameters to the mapped corresponding entities of the game engine object.

2. The method of claim 1, further comprising
mapping at least one of the one or more nodes of the scene description update parameters to corresponding entities of a node graph,
wherein the node graph corresponds to at least one of the one or more nodes of the scene description update parameters.

3. The method of claim 2, further comprising applying the scene description update parameters to elements of the node graph.

4. The method of claim 1, wherein the one or more nodes are part of a virtual scene graph.

5. The method of claim 1, wherein, for at least one node, the patch data comprises:
an operation identifier,
a path to a JavaScript Object Notation (JSON) element of the scene description data, and a value to apply.

6. The method of claim 1, wherein, for at least one node, the patch data comprises one or more values to associate with the at least one node.

7. The method of claim 1, further comprising:
applying the scene description update parameters to a Graphics Library Transmissions Format (glTF) file,
wherein the glTF file comprises elements corresponding to a node graph.

8. The method of claim 1, further comprising:
applying the scene description update parameters to a file,
wherein the file comprises elements corresponding to a node graph.

9. The method of claim 1, wherein the patch data is in Javascript Object Notation (JSON) format.

10. The method of claim 1, wherein parsing the patch data further comprises detecting, in the patch data, a value structure comprising one or more values corresponding to a parsed node.

11. The method of claim 1, wherein parsing the patch data comprises:
detecting, in the patch data, data indicating an operation to perform on a parsed node,
wherein the parsed node is selected from the one or more nodes; and
detecting, in the patch data, data indicating a location of the parsed node.

12. The method of claim 1, wherein parsing the patch data comprises:
detecting, in the patch data, an operation field; and
detecting, in the patch data, a path field corresponding to a parsed node.

13. The method of claim 12, wherein the operation field indicates an operation selected from the list consisting of add, remove, replace, move, and copy.

14. The method of claim 12,
wherein the detected operation field indicates a replace operation, and
wherein applying the scene description update parameters comprises deleting the parsed node corresponding to the detected path field.

15. The method of claim 3, wherein parsing the patch data comprises:
detecting, in the patch data, an operation field;
detecting, in the patch data, a path field corresponding to a parsed node; and
detecting, in the patch data, a value structure comprising one or more values corresponding to the parsed node,
wherein the detected operation field indicates an add operation, and
wherein applying the scene description update parameters comprises:
adding, to the node graph, the parsed node corresponding to the detected path field; and
adding, to the node graph, values for the parsed node,
wherein the values for the parsed node are indicated by the detected value structure.

16. The method of claim 3, wherein parsing the patch data comprises:
detecting, in the patch data, an operation field;
detecting, in the patch data, a path field corresponding to a parsed node; and
detecting, in the patch data, a value structure comprising one or more values corresponding to the parsed node,
wherein the detected operation field indicates a replace operation, and
wherein applying the scene description update parameters comprises replacing, for the parsed node, values of the node graph with values indicated by the detected value structure.

17. An apparatus comprising:
a processor; and
memory storing instructions operative, when executed by the processor, to cause the apparatus to:
obtain patch data,
wherein the patch data specifies an update to scene description data for a three-dimensional (3D) scene, and
wherein the scene description data comprises scene element information describing at least one scene element for a subset of the scene;
parse the patch data into scene description update parameters for one or more nodes;
map at least one of the one or more nodes of the scene description update parameters to corresponding entities of a game engine object; and
apply the scene description update parameters to the mapped corresponding entities of the game engine object.

18-20. (canceled)

21. A method comprising:
obtaining patch data,
wherein the patch data specifies an update to scene description data for a three-dimensional (3D) scene, and
wherein the scene description data comprises scene element information describing at least one scene element for a subset of the scene;
parsing the patch data into scene description update parameters for a node; and
applying the scene description update parameters for the node to corresponding entities of the game engine object.

22-23. (canceled)

24. The method of claim 21, wherein, for at least one node, the patch data comprises:
an operation identifier,
a path to a JavaScript Object Notation (JSON) element of the scene description data, and
a value to apply.

25-34. (canceled)

35. The method of claim 21, wherein parsing the patch data comprises:
detecting, in the patch data, an operation field;
detecting, in the patch data, a path field corresponding to a parsed node; and
detecting, in the patch data, a value structure comprising one or more values corresponding to the parsed node,
wherein the detected operation field indicates a replace operation, and
wherein applying the scene description update parameters comprises replacing, for the parsed node, values of the node graph with values indicated by the detected value structure.

36-39. (canceled)
